(19) United States
(12) Patent Application Publication
(10) Pub. No.: US 2019/0188635 A1
(43) Pub. Date: Jun. 20, 2019

(54) AUTOMATED VEHICLE AND METHOD FOR SERVICING DISABLED VEHICLES

(71) Applicant: Walmart Apollo, LLC, Bentonville, AR (US)

(72) Inventors: Donald R. High, Noel, MO (US); John J. O'Brien, Farmington, AR (US); David C. Winkle, Bella Vista, AR (US); Todd D. Mattingly, Bentonville, AR (US)

(21) Appl. No.: 16/191,146

(22) Filed: Nov. 14, 2018

Related U.S. Application Data
(60) Provisional application No. 62/599,321, filed on Dec. 15, 2017.

(51) Int. Cl. G06Q 10/08; G06Q 10/00; G05D 1/00; G08G 1/00

(52) U.S. Cl. CPC G06Q 10/0832; G06Q 10/20; G05D 2201/0213; G08G 1/205; G05D 1/0088

(57) ABSTRACT

An economic priority of a cargo is determined based upon the financial information and delivery restrictions. Based upon sensed readings, the condition of the disabled delivery vehicle is determined and one or more proposed actions performable by the automated autonomous repair vehicle that would remedy the operational problems of the disabled delivery vehicle are identified. One (or more) of the proposed actions is selected based upon the economic priority of the cargo. The automated autonomous repair vehicle is caused to perform the selected action.

### CROSS-REFERENCE TO RELATED APPLICATION

This application claims the benefit of the following U.S. Provisional Application No. 62/599,321 filed Dec. 15, 2017, which is incorporated herein by reference in its entirety.

### TECHNICAL FIELD

These teachings relate generally to the servicing of disable vehicles and, more specifically, to servicing these vehicles based upon the economic value of the cargo that the vehicles are transporting.

### BACKGROUND

Vehicles transport different types of merchandise between different shipping sources and destinations. In one example, trucks transport goods from warehouses to retail stores. In another example, delivery vehicles transport packages from warehouses to residences of customers (or to businesses).

Vehicles sometimes become disabled. For example, the engine of a vehicle may break down or otherwise become inoperative. In another example, the vehicle may be involved in an accident and may not be able to move either because of damage to the vehicle or due to legal restrictions that prevent the vehicle from leaving the scene of the accident.

In any case, when a vehicle is disabled undesirable outcomes can occur regarding the cargo that the vehicle is carrying. For example, if the vehicle is carrying a refrigerated cargo and the refrigeration system is disabled (or the vehicle is significantly delayed in transit), the cargo may spoil or become otherwise unusable. In another example, if the vehicle cannot move, the cargo may be susceptible to theft or the vehicle to vandalism.

Manually operated tow trucks have been used to service disabled vehicles. More specifically, once a vehicle has broken down a tow truck can be dispatched to service or tow the disabled vehicle. Unfortunately, manually operated tow trucks are expensive to operate. Additionally, manually operated tow trucks require that a driver is readily available. However, in some cases, a driver for the tow truck is not immediately available, thereby delaying the response time and jeopardizing the survival of the cargo.

### BRIEF DESCRIPTION OF THE DRAWINGS

The above needs are at least partially met through provision of approaches that automatically servicing disable vehicles particularly when studied in conjunction with the drawings, wherein:

FIG. 1 comprises a diagram of a system as configured in accordance with various embodiments of these teachings;

FIG. 2 comprises a flowchart of a system as configured in accordance with various embodiments of these teachings;

FIG. 3 comprises a flowchart of a system as configured in accordance with various embodiments of these teachings;

FIG. 4 comprises a flowchart of a system as configured in accordance with various embodiments of these teachings.

### DETAILED DESCRIPTION

Generally speaking, many of these embodiments provide for an automated repair vehicle that obtains financial information of the cargo of a target vehicle that has become disabled. The information might include a dollar value of the cargo. The financial information is used to determine the priority of the cargo, e.g., whether the cargo a high-value item with a high delivery priority. The repair vehicle also obtains sensed information about the physical characteristics of the target vehicle. The sensed information may, in aspects, include images of the target vehicle. The sensed information is used to determine a condition of the vehicle, e.g., has the target vehicle been involved in an accident.

Next, potential actions are determined based upon the condition of the delivery vehicle, e.g., tow the vehicle to a repair center, leave the vehicle where it is, or attempt to repair the target vehicle where it sits. Then, one (or more) of the actions are selected based upon the economic priority of the cargo. For example, the condition of the vehicle may be such that two actions including towing the delivery vehicle or repairing the vehicle in place are possible. However, the cargo may be of such high value that the action that is selected is to immediately tow the vehicle to prevent loss of the cargo.

In many of these embodiments, an automated autonomous repair vehicle is configured to maneuver to a location of a disabled delivery vehicle that is delivering a cargo of merchandise. The automated repair vehicle includes an interface, a sensing device, and a control circuit.

The sensing device is configured to obtain information concerning physical characteristics of a disabled delivery vehicle that is experiencing operational problems. The disabled delivery vehicle carries a cargo.

The control circuit is coupled to the interface and the sensing device. The control circuit is automatically configured to receive the sensed information from the sensing device via the interface, obtain financial information and delivery restrictions concerning the cargo via the interface, and determine an economic priority of the cargo based upon the financial information and delivery restrictions. The control circuit is further configured to determine, based upon the sensed information and the condition of the disabled delivery vehicle, one or more proposed actions performable by the automated repair vehicle that would remedy the operational problems of the disabled delivery vehicle.

The control circuit is configured to then select one of the proposed actions based upon the economic priority of the cargo. The control circuit is further configured to subsequently cause the automated autonomous repair vehicle to perform the selected action.

In aspects, the automated autonomous repair vehicle further includes a towing apparatus. In examples, the control circuit is configured to maneuver the automated autonomous repair vehicle into a position to tow the disabled delivery vehicle. The control circuit transmits an electronic signal to actuate the towing apparatus when the automated autonomous repair vehicle is in position.

In other aspects, the automated autonomous repair vehicle further includes a repair apparatus. In examples, the control circuit is configured to maneuver the automated autonomous repair vehicle into a position to repair the disabled delivery vehicle. The control circuit transmits an electronic signal to actuate the repair apparatus when the automated autonomous repair vehicle is in position. In some examples, the repair apparatus comprises a robotic arm or micro drones. Other examples are possible.

In other examples, the economic priority of the cargo comprises a relative importance of delivery of the cargo based upon a financial value of the cargo, or a liability or risk of leaving cargo in place. Other examples of economic priority are possible.

In yet other examples, the condition of the disabled delivery vehicle comprises the physical position of the disabled delivery vehicle with respect to the automated autonomous repair vehicle, or an operational status of the disabled delivery vehicle. Other examples are possible.

In aspects, the financial information relates to the financial value of the cargo, the cold chain requirements concerning the cargo, or legal, regulatory, or administrative guidelines concerning delivery of the cargo. Other examples are possible.

In other aspects, the sensing device is a camera, or a code reading apparatus configured to obtain operating codes from the disabled delivery vehicle. Other examples of sensing devices are possible.

In still other examples, the disabled delivery vehicle is an aerial drone, a manned delivery truck, or an automated ground vehicle. Other examples of vehicles are possible.

In others of these embodiments, an automated repair vehicle is maneuvered to a location of a disabled delivery vehicle that is delivering a cargo. Information concerning physical characteristics of the disabled delivery vehicle is sensed. Financial information and delivery restrictions concerning the cargo is obtained.

An economic priority of the cargo based upon the financial information and delivery restrictions is determined. Based upon the sensed readings, the condition of the disabled delivery vehicle is determined and one or more proposed actions performable by the automated autonomous repair vehicle that would remedy the operational problems of the disabled delivery vehicle are identified.

One (or more) of the proposed actions is selected based upon the economic priority of the cargo. The automated autonomous repair vehicle is caused to perform the selected action.

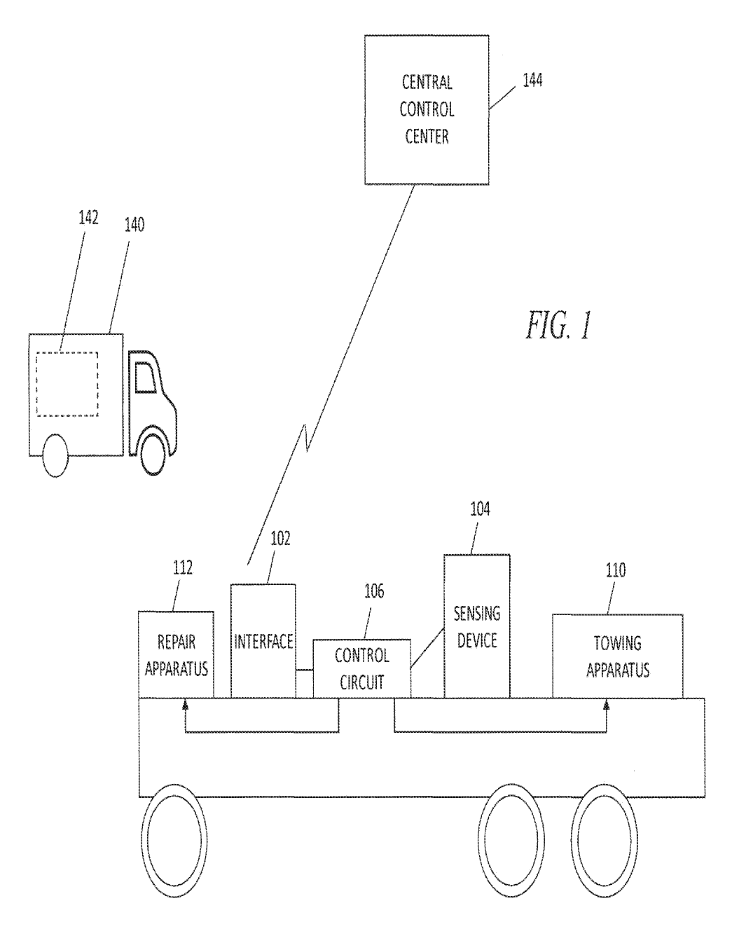

Referring now to FIG. 1, one example of an automated autonomous repair vehicle 100 that is configured to maneuver to a location of a disabled delivery vehicle 140 is described. The automated repair vehicle 100 includes an interface 102, a sensing device 104, and a control circuit 106. The vehicle 100 may include a propulsion system, wheels, a frame, and other components typically found in or included with vehicles. In aspects, the automated autonomous repair vehicle 100 further includes a towing apparatus 110. In other aspects, the automated autonomous repair vehicle 100 further includes a repair apparatus 112.

The towing apparatus 110 is any type of mechanism configured for the towing of the disabled vehicle 140. The towing apparatus 110 may be a conventional towing device used on conventional tow trucks as known to those skilled in the art. In aspects, the towing apparatus 110 may include wheels, pulleys, gears that operate a cable (or cables), which attach to the disabled vehicle 140. In still other examples, the towing apparatus 140 includes a magnetic coupler that couples to the disabled vehicle 140.

The repair apparatus 112 is any type of device (or devices) that is configured to repair disabled vehicle. In examples, the repair apparatus 112 comprises a robotic arm or micro drones (which can perform repair activities). Other examples are possible.

The disabled vehicle 140 may be any type of vehicle that is inoperative in any respect, unable to move, or somehow restricted in movement. In examples, the disabled vehicle 140 is an aerial drone, a manned delivery truck, or an automated ground vehicle. In other examples, the disabled vehicle 140 is a delivery vehicle with cargo 142. The cargo 142 may be any type of products such as retail merchandise, refrigerated products, or frozen products. Other examples are possible. The vehicle 140 may also include components that preserve or protect the cargo 142 (e.g., refrigeration units or a security system).

The sensing device 104 is any type of device that can measure physical parameters. In examples, the sensing device 104 may be a camera and obtain images. In other aspects, the sensing device 104 is a code reading apparatus configured to obtain operating (or status) codes from the disabled delivery vehicle. Other examples of sensing devices are possible. In another example, the sensing device 104 detects motion, speed, or acceleration of an object.

In still other examples, the sensing device 104 receives transmitted information (e.g., information from a control center). For instance, the sensing device 104 may receive transmitted electronic messages that include condition information or status. It will be appreciated that multiple sensing devices can also be used.

In aspects, the sensing device 104 is configured to obtain information concerning physical characteristics of a disabled delivery vehicle that is experiencing operational problems. For example, the sensing device 104 may obtain visual images (or images measured at any other wavelength) of the disabled vehicle.

The interface 102 is an electronic device that includes any combination of computer hardware or software. In some aspects, the interface 102 is configured to transmit electronic information, electronic messages, or electronic control signals to operate different components of the vehicle 100 or to entities outside of the vehicle 100. The interface 102 is also configured to receive electronic information, for example, from the sensing device 104.

The control circuit 106 is coupled to the interface 102 and the sensing device 104. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 106 may be configured (for example, by using corresponding programming stored in a memory as will be well understood by those skilled in the art) to carry out one or more of the steps, actions, and/or functions described herein.

The control circuit 106 is automatically configured to receive the sensed information from the sensing device 104 via the interface 102, obtain financial information and delivery restrictions concerning the cargo via the interface 102, and determine an economic priority of the cargo 142 based upon the financial information and delivery restrictions.

The control circuit 106 is further configured to determine, based upon the sensed information and the condition of the disabled delivery vehicle 140, one or more proposed actions performable by the automated repair vehicle that would remedy the operational problems of the disabled delivery vehicle 140. The control circuit 106 is then configured to select one of the proposed actions based upon the economic priority of the cargo 142. The control circuit 106 is further configured to subsequently cause the automated autonomous repair vehicle 100 to perform the selected action.

In one example, the selected action is to tow the vehicle 140 to a service center or to some other location. In aspects, the control circuit 106 is configured to maneuver the automated autonomous repair vehicle 100 into a position to tow the disabled delivery vehicle 140. The control circuit 106 transmits an electronic signal to actuate the towing apparatus 110 when the automated autonomous repair vehicle 100 is in the position.

In another example, the selected action is to repair the vehicle 140. In aspects, the control circuit 106 is configured to maneuver the automated autonomous repair vehicle 100 into a position to repair the disabled delivery vehicle 140. The control circuit 106 transmits an electronic signal to actuate the repair apparatus 112 when the automated autonomous repair vehicle 100 is in the position.

Information relating to the economic priority of the cargo 142 may be represented in a variety of forms. In some aspects, the economic priority of the cargo 142 comprises a relative importance of delivery of the cargo 142 based upon a financial value of the cargo, or a liability or risk of leaving cargo 142 in place. Other examples of economic priority are possible. The economic priority information may be transmitted to the vehicle 100 from a central control center 144.

Condition information of the disabled vehicle 140 also may be of a variety of different types and forms. For instance, the condition of the disabled delivery vehicle 140 may comprise the physical position of the disabled delivery vehicle with respect to the automated autonomous repair vehicle, or an operational status (e.g., operative, inoperative, moving, not-moving) of the disabled delivery vehicle 140. Other examples are possible. The condition information may be transmitted to the vehicle 100 from the disabled vehicle 140 (e.g., the disabled vehicle 140 may transmit a signal with condition information), or may be sensed by the measurement device 104. In other aspects, the condition information may be transmitted to the vehicle 100 from a central control center 144 (via the interface 102).

Financial information of the cargo 142 may also be a variety of different forms. For example, the financial information may relate to the financial value of the cargo, the cold chain requirements concerning the cargo, or legal, regulatory, or administrative guidelines concerning delivery of the cargo. Other examples are possible.

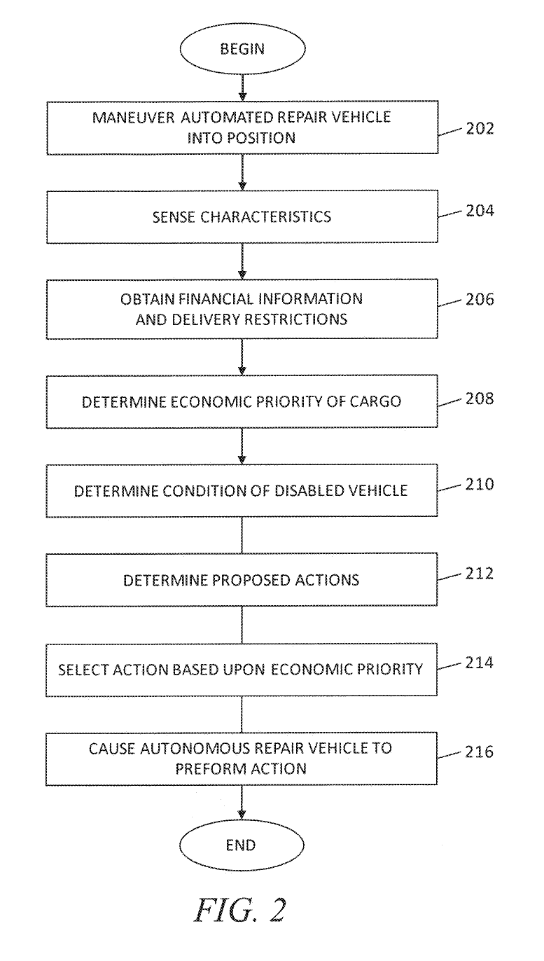

Referring now to FIG. 2, one example of an approach for servicing a disabled vehicle is described. At step 202, an automated repair vehicle is maneuvered to a location of a disabled delivery vehicle that is delivering a cargo. The automated repair vehicle can be directed by the disabled vehicle, by a central control center, or by a combination of these devices.

At step 204, information concerning physical characteristics of the disabled delivery vehicle is sensed. In examples, the physical characteristics may include the location (e.g., obtained from a location service such as a GPS service) or the condition of the vehicle (e.g., operate, inoperative, moving, or not moving). Physical characteristics can be determined, for example, by processing images from a camera. For instance, smoke or fire coming from a vehicle indicates that the vehicle is disabled. The images may also indicate that the vehicle is on its side or off the road further indicating the vehicle is inoperative.

At step 206, financial information and delivery restrictions concerning the cargo is obtained. For example, the financial information and delivery restrictions may include the price (or other financial value) of the cargo, or cold chain requirements concerning the cargo.

At step 208, an economic priority of the cargo based upon the financial information and delivery restrictions is determined. In examples, the economic priority of the cargo comprises a relative importance of delivery of the cargo based upon a financial value of the cargo, or a liability or risk of leaving cargo in place.

At step 210, the condition of the disabled delivery vehicle is determined based upon the sensed readings. At step 212, one or more proposed actions performable by the automated autonomous repair vehicle that would remedy the operational problems of the disabled delivery vehicle are identified. For example, if the vehicle is along the side of the road and accessible, then towing and/or repair actions may be possible. However, if the vehicle has left the road way and is positioned in a ditch, the only option may be to save the cargo. In other examples, no action may be possible.

At step 214, one of the proposed actions is selected based upon the economic priority of the cargo. For example, if the actions are towing the vehicle or repairing the vehicle in place and the economic value of the cargo is high, then the towing option may be selected. Otherwise, the repair-in-place option may be selected.

At step 216, the automated autonomous repair vehicle is caused to perform the selected action. For example, the vehicle may be maneuvered to the proper location, the towing mechanism actuated and attached to the disabled vehicle, and the disabled vehicle towed. In another example, the vehicle may be maneuvered to the proper location, the repair apparatus or device (e.g., drones) actuated and repairs made to the disabled vehicle.

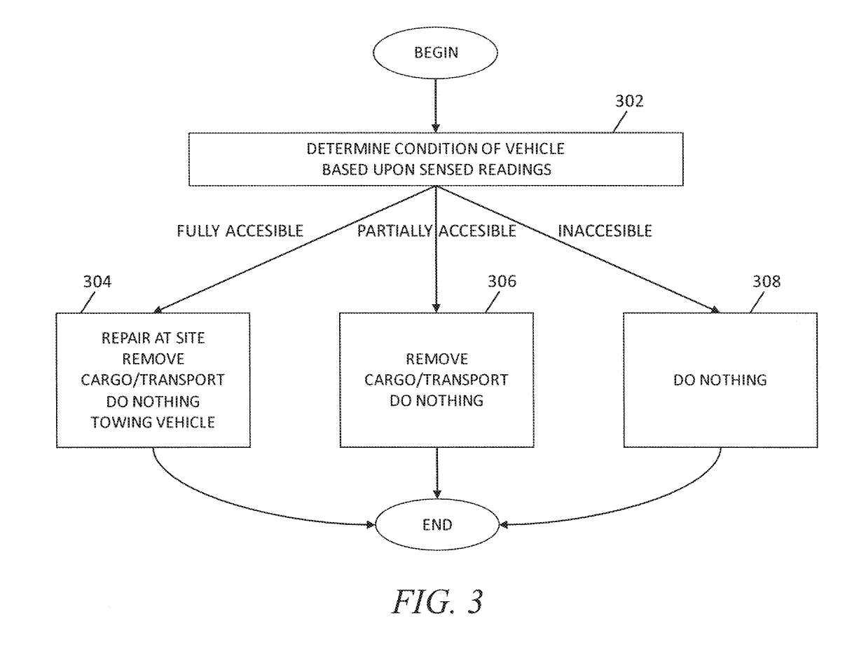

Referring now to FIG. 3, one example of an approach for determining proposed actions based upon the condition of a disabled vehicle is described.

At step 302, the condition of the disabled vehicle is determined based upon sensed readings. For example, an image taken by a camera can be analyzed (using image analysis techniques as known to those skilled in the art) to determine whether the vehicle is accessible. The condition may also be sensed by a sensing device. For instance, the disabled vehicle may report or broadcast condition information via a transmitter.

In this example, three conditions exist: fully accessible, partially accessible, or inaccessible. Inaccessible means any condition where the disabled vehicle is not available or reachable for any reason. For example, the disabled vehicle may be turned on its side, may be burning, or may be otherwise damaged. The disabled vehicle may also be inaccessible because it has been involved in an accident (e.g., and the police have not yet released the vehicle). Fully accessible means that the vehicle is completely accessible and that there are no restrictions in accessing the vehicle. Partially accessible, means that the disabled vehicle has partial accessibility, but that not all actions are possible. In this example, partial accessibility means that the cargo is accessible, but the vehicle cannot be moved.

At step 304, it has been determined that the disabled vehicle is fully accessible. The potential actions are to repair the vehicle on site, towing the vehicle, remove the cargo and transport to a different location, tow the vehicle, or do nothing.

At step 306, it has been determined that the disabled vehicle is partially accessible. The potential actions are to remove the cargo and transport to a different location, or do nothing.

At step 308, it has been determined that the disabled vehicle is inaccessible. The only action is to do nothing. In this case, the vehicle is left where it sits.

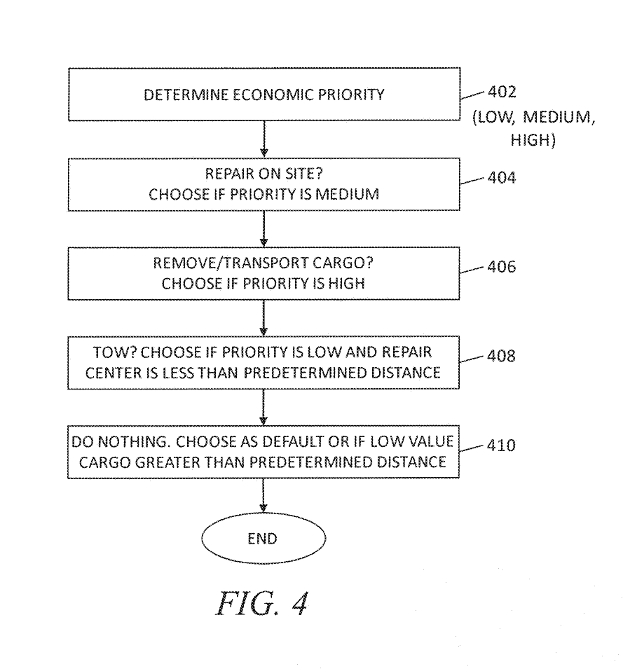

Referring now to FIG. 4, one example of an approach for selecting proposed actions is described. In this example, the actions of FIG. 3 are filtered by the algorithm of FIG. 4.

At step 402, the economic priority of the cargo is determined based upon the financial information and delivery restrictions. Financial information may include the absolute value of the cargo. Delivery restrictions may relate to cold chain requirements. In examples, the economic priority of the cargo comprises a relative importance of delivery of the cargo based upon a financial value of the cargo, or a liability or risk of leaving cargo in place.

In this example, the economic priority can be high, medium, and low. High priority cargo are premium items such as premium frozen grocery items, or high-valued electronic. Medium priority items may be items of average value, for example, within a certain price range. Low priority items are items that are easily replaceable or below a value threshold.

Each action is evaluated for selection based upon the economic priority.

At step 404, repairing the vehicle on site is evaluated. This option is selected if the priority is medium.

At step 406, removing the cargo and transport to a different location is evaluated. This option is selected if the priority is high.

At step 408, towing the vehicle is considered. This option is selected if the priority is low, and a repair center is within a predetermined distance of the disabled vehicle.

At step 410, doing nothing is evaluated. This option is selected as a default or if the priority is low and the vehicle is beyond a predetermined distance to a repair center.

It will be appreciated that the approaches of FIG. 3 and FIG. 4 are examples only and that other algorithms are possible. It is all possible that multiple actions can be performed. For example, repairing the vehicle may be first attempted, and if the repairs are not successful then the vehicle can be towed.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An automated autonomous repair vehicle, the automated autonomous repair vehicle being configured to maneuver to a location of a disabled delivery vehicle that is delivering a cargo of merchandise, the automated repair vehicle comprising:
an interface;
a sensing device that is configured to obtain information concerning physical characteristics of a disabled delivery vehicle that is experiencing operational problems, the disabled delivery vehicle carrying a cargo;
a control circuit coupled to the interface and the sensing device;
wherein the control circuit is automatically configured to:
receive the sensed information from the sensing device via the interface;
obtain financial information and delivery restrictions concerning the cargo via the interface;
determine an economic priority of the cargo based upon the financial information and delivery restrictions;
determine, based upon the sensed information, the condition of the disabled delivery vehicle;
identify one or more proposed actions performable by the automated repair vehicle that would remedy the operational problems of the disabled delivery vehicle;
select one of the proposed actions based upon the economic priority of the cargo; and
subsequently cause the automated autonomous repair vehicle to perform the selected action.

2. The automated autonomous repair vehicle of claim 1, further comprising a towing apparatus, and wherein the control circuit is configured to maneuver the automated autonomous repair vehicle into a position to tow the disabled delivery vehicle, wherein the control circuit transmits an electronic signal to actuate the towing mechanism when the automated autonomous repair vehicle is in the position.

3. The automated autonomous repair vehicle of claim 1, further comprising a repair apparatus, and wherein the control circuit is configured to maneuver the automated autonomous repair vehicle into a position to repair the disabled delivery vehicle, wherein the control circuit transmits an electronic signal to actuate the repair apparatus when the automated autonomous repair vehicle is in the position.

4. The automated autonomous repair vehicle of claim 3, wherein the repair apparatus comprises a robotic arm or micro drones.

5. The automated autonomous repair vehicle of claim 1, wherein the economic priority of the cargo comprises a relative importance of delivery of the cargo based upon a financial value of the cargo, or a liability or risk of leaving cargo in place.

6. The automated autonomous repair vehicle of claim 1, wherein the condition of the disabled delivery vehicle comprises the physical position of the disabled delivery vehicle with respect to the automated autonomous repair vehicle, or an operational status of the disabled delivery vehicle.

7. The automated autonomous repair vehicle of claim 1, wherein the financial information relates to the financial value of the cargo, the cold chain requirements concerning the cargo, or legal, regulatory, or administrative guidelines concerning delivery of the cargo.

8. The automated autonomous repair vehicle of claim 1, wherein the sensing device is a camera, or a code reading apparatus configured to obtain operating codes from the disabled delivery vehicle.

9. The automated autonomous repair vehicle of claim 1, wherein the disabled delivery vehicle is an aerial drone, a manned delivery truck, or an automated ground vehicle.

10. A method of assisting a disabled delivery vehicle using an automated autonomous repair vehicle,
maneuvering an automated repair vehicle to a location of a disabled delivery vehicle that is delivering a cargo;
sensing information concerning physical characteristics of the disabled delivery vehicle;
obtaining financial information and delivery restrictions concerning the cargo;
determining an economic priority of the cargo based upon the financial information and delivery restrictions,
based upon the sensed readings, determining the condition of the disabled delivery vehicle and identifying one or more proposed actions performable by the automated autonomous repair vehicle that would remedy the operational problems of the disabled delivery vehicle;
selecting one of the proposed actions based upon the economic priority of the cargo; and
causing the automated autonomous repair vehicle to perform the selected action.

11. The method of claim 10, wherein the automated autonomous repair vehicle comprises a towing apparatus, and further comprising maneuvering the automated autonomous repair vehicle into a position to tow the disabled delivery vehicle, wherein an electronic signal actuates the towing mechanism when the automated autonomous repair vehicle is in the position.

12. The method of claim 10, wherein the automated autonomous repair vehicle comprises a repair apparatus, and further comprising maneuvering the automated autonomous repair vehicle into a position to repair the disabled delivery vehicle, wherein an electronic signal actuates the repair apparatus when the automated autonomous repair vehicle is in the position.

13. The method of claim 12, wherein the repair apparatus comprises a robotic arm or micro drones.

14. The method of claim 10, wherein the economic priority of the cargo comprises a relative importance of delivery of the cargo based upon a financial value of the cargo, or a liability or risk of leaving cargo in place.

15. The method of claim 10, wherein the condition of the disabled delivery vehicle comprises the physical position of the disabled delivery vehicle with respect to the automated autonomous repair vehicle, or an operational status of the disabled delivery vehicle.

16. The method of claim 10, wherein the financial information relates to the financial value of the cargo, the cold chain requirements concerning the cargo, or legal, regulatory, or administrative guidelines concerning delivery of the cargo.

17. The method of claim 10, wherein the sensing device is a camera or a code reading apparatus configured to obtain operating codes from the disabled delivery vehicle.

18. The method of claim 10, wherein the disabled delivery vehicle is an aerial drone, a manned delivery truck, or an automated ground vehicle.
